(19) United States
(12) Patent Application Publication
(10) Pub. No.: US 2012/0045048 A1
(43) Pub. Date: Feb. 23, 2012

(54) RINGTONE MANAGEMENT FOR CONTACTS ACROSS COMMUNICATION ACCESS SYSTEMS

(75) Inventors: Vijay Karani, Fremont, CA (US); Jatin Patel, Tinton Falls, NJ (US)

(73) Assignee: AVAYA, INC., Basking Ridge, NJ (US)

(21) Appl. No.: 12/859,472

(22) Filed: Aug. 19, 2010

(51) Int. Cl. H04M 3/42

(52) U.S. Cl. 379/207.16

(57) ABSTRACT

Ringtone management devices, systems, and methods for supporting contacts across communication access systems are provided herein. In one embodiment, the communication access system may be an enterprise access system. The communication access system can allow a plurality of different client devices in the enterprise access system, each associated with a particular set of incoming caller identifiers, to all be rung with an outgoing ringtone that identifies the incoming caller. In this manner, a user is provided with a consistent ringtone at each of the user's devices that identifies a particular incoming caller.

### RELATED APPLICATION

This application is related to the co-pending U.S. patent application Ser. No. ______, entitled RINGBACK TONE MANAGEMENT FOR CONTACTS ACROSS COMMUNICATION ACCESS SYSTEMS, filed on ______, and which is incorporated herein by reference in its entirety.

### FIELD OF THE DISCLOSURE

The field of the disclosure relates to managing multiple client devices in an unified communication system. The field of the disclosure also relates to managing ringtones for a user of an enterprise unified communication system.

### BACKGROUND

Unified communication systems are generally communication systems that can support operability and interoperability of a plurality of user devices. In this regard, users of a unified communication system may have numerous communication devices at their disposal that are registered with such system. These communication devices may include presences at home, the office, and mobile in the form of various types of mobile terminals. Some calling devices support advanced ringtone features to permit a user to identify a caller by ringtone. Other communication devices do not support ringtone features to identify a caller based upon a ringtone.

An enterprise communication system is one example of a communications system that may be configured to provide unified communications support. However, unified communication systems fail to provide support for ringtone features across multiple devices including, for example, computers, thin-clients devices, thick client devices, enterprise mobile terminals and phones. As a result, there is no unified approach for managing and utilizing ringtone features in an enterprise unified communication system. Accordingly, there is a need to provide a unified approach to system wide ringtone management.

### SUMMARY OF THE DETAILED DESCRIPTION

Embodiments in the detailed description include ringtone management devices, systems, and methods for contacts across a communication access system. As an example, the communication access system may be an enterprise access system. The embodiments provided herein allows a plurality of different client devices in the communication access system, each associated with a particular set of incoming caller identifiers, to all be rung with an outgoing ringtone that identifies the incoming caller. In this manner, as an example, a user can be provided with a consistent ringtone at each of the user's devices that identifies a particular incoming caller.

In this regard, in a first embodiment, a ringtone management system is provided. The ringtone management system includes a server configured to receive an incoming call from an incoming caller identifier, wherein the incoming call is directed to a destination caller identifier. The server identifies a user profile from among a plurality of user profiles that corresponds to the destination caller identifier, where the user profile is associated with a plurality of client devices and a plurality of contacts. Thereafter, the server determines whether the plurality of contacts includes a contact associated with a caller identifier that matches the incoming caller identifier. In response to determination that the plurality of contacts includes the contact associated with the caller identifier that matches the incoming caller identifier, the server selects a ringtone associated with the caller identifier as an outbound ringtone and rings the plurality of client devices with the outbound ringtone.

Another embodiment includes a method for managing a ringtone. The method may include receiving an incoming call from an incoming caller identifier, wherein the incoming call is directed to a destination caller identifier. The method may further include identifying a user profile among a plurality of user profiles that correspond to the destination caller identifier, wherein the user profile is associated with a plurality of client devices and includes a plurality of contacts. The method may further include determining whether the plurality of contacts includes a contact associated with a caller identifier that matches the incoming caller identifier, and in response to determination that the plurality of contacts includes the contact associated with the caller identifier that matches the incoming caller identifier, selecting a ringtone associated with the caller identifier as an outbound ringtone. The method may further include ringing the plurality of client devices with the outbound ringtone.

Another example embodiment includes a method for reconciling ringtones across multiple devices. The method may include identifying, from the user profile, one or more client devices having a local address book. The method further includes requesting, from each of the one or more client devices having the local address book, local address book information. The method further includes resolving conflicts between the local address book information received from each of the one or more client devices having the local address book and an address book associated with the user profile to generate conflict resolution information. The method further includes reconciling ringtones stored in the address book associated with the user profile based upon the conflict resolution information. The method further includes broadcasting updated local address book information to each client device of the one or more client devices.

Another example includes a system for reconciling ringtones across multiple devices. The system for reconciling ringtones across multiple devices includes a server configured to identify, from the user profile, one or more client devices having a local address book. The server requests, from each of the one or more client devices having the local address book, local address book information. The server resolves conflicts between the local address book information received from each of the one or more client devices having the local address book and an address book associated with the user profile to generate conflict resolution information. The server reconciles ringtones stored in the address book associated with the user profile based upon the conflict resolution information. Thereafter, the server broadcasts updated local address book information to each client device of the one or more client devices.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention:

FIG. 1 depicts an example unified communication (UC) system;

FIG. 2 depicts an example of a user profile database;

FIG. 3 depicts an example user profile address book associated with one of the user profiles of FIG. 2;

FIG. 4 depicts another example of a user profile address book for groups of contacts associated with one of the user profiles of FIG. 2;

FIG. 5 depicts an operation for selecting a ringtone to ring a client device of a user of the example enterprise uniform communication system of FIG. 1;

FIG. 6 depicts a call flow diagram for ringing the client device;

FIG. 7 depicts a call flow diagram for the ringtone management system;

FIG. 8 depicts an operation for selecting a ringback tone to stream to a calling device; and

FIG. 9 depicts a call flow diagram for the ringback tone management system.

### DETAILED DESCRIPTION

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

Embodiments in the detailed description include ringtone management devices, systems, and methods for contacts across a communication access system. As an example, the communication access system may be an enterprise access system. The embodiments provided herein allows a plurality of different client devices in the communication access system, each associated with a particular set of incoming caller identifiers, to all be rung with an outgoing ringtone that identifies the incoming caller. In this manner, as an example, a user can be provided with a consistent ringtone at each of the user's devices that identifies a particular incoming caller.

In this regard, in a first embodiment, a ringtone management system is provided. The ringtone management system includes a server configured to receive an incoming call from an incoming caller identifier, wherein the incoming call is directed to a destination caller identifier. The server identifies a user profile from among a plurality of user profiles that corresponds to the destination caller identifier, where the user profile is associated with a plurality of client devices and a plurality of contacts. Thereafter, the server determines whether the plurality of contacts includes a contact associated with a caller identifier that matches the incoming caller identifier. In response to determination that the plurality of contacts includes the contact associated with the caller identifier that matches the incoming caller identifier, the server selects a ringtone associated with the caller identifier as an outbound ringtone and rings the plurality of client devices with the outbound ringtone.

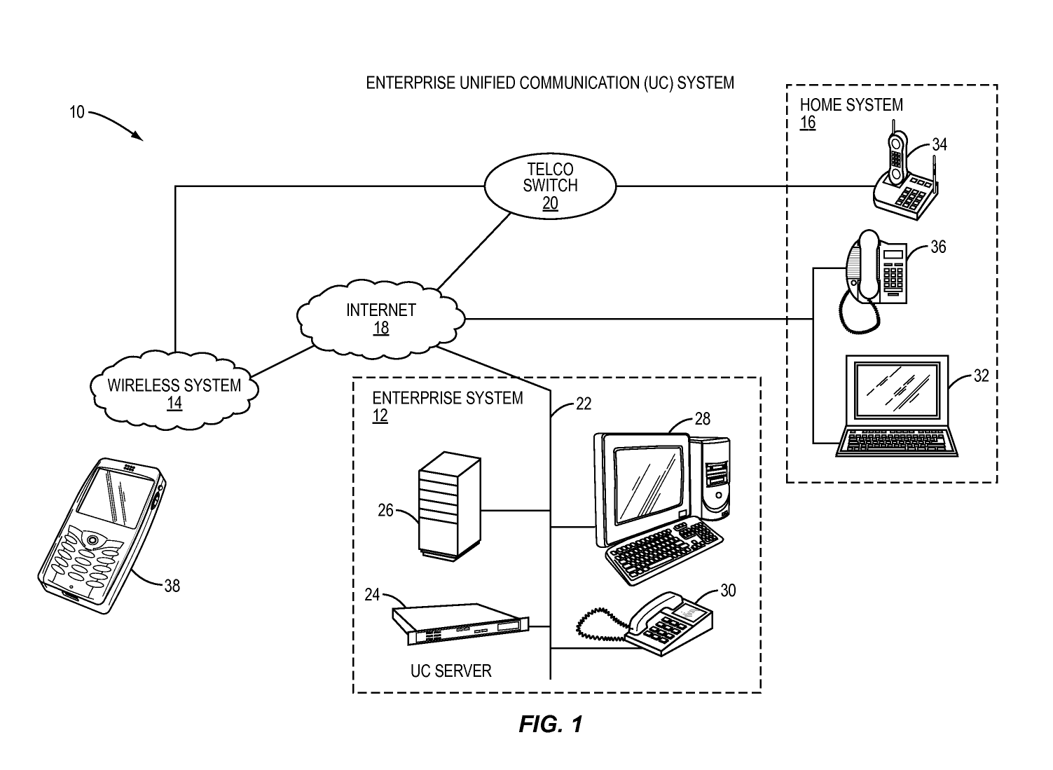

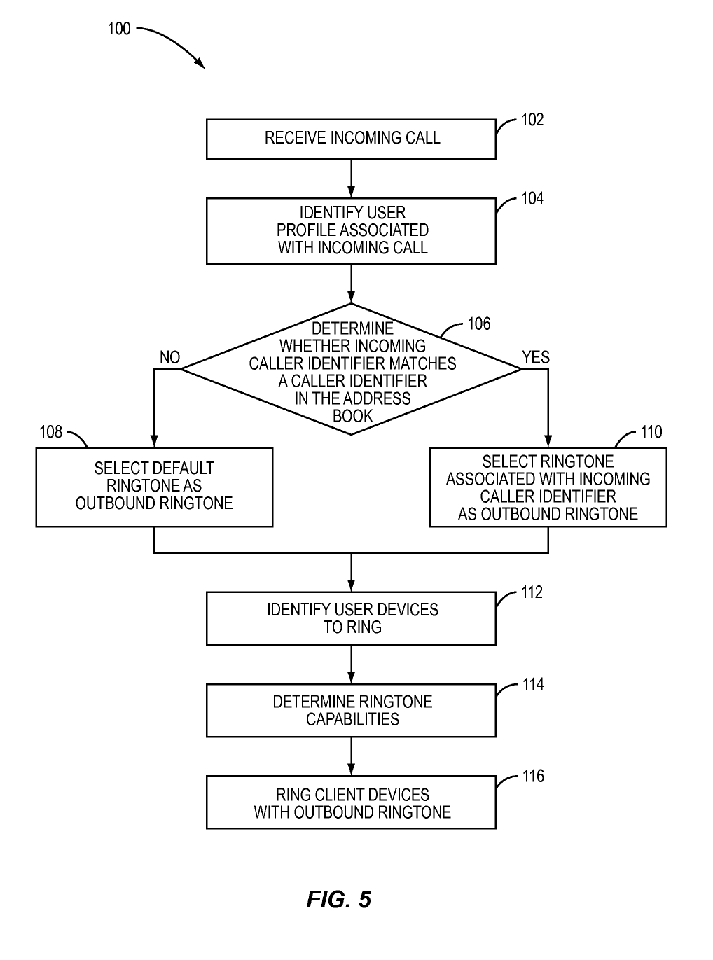

Before discussing operational examples, starting at FIG. 5, that provide for a plurality of different client devices in the communication access system to be rung with an outgoing ringtone that identifies the incoming caller, FIGS. 1-4 are first discussed. FIGS. 1-4 depict an exemplary communication access system and enterprise system that can support a plurality of different client devices being rung with an outgoing ringtone that identifies the incoming caller.

In this regard, FIG. 1 depicts an example unified communication (UC) system 10 that is configured to support a plurality of client devices from a plurality of users. The UC system supports a plurality of different client devices in the enterprise access system, each associated with a particular set of client caller identifiers, to all be rung with an outgoing ringtone that identifies the incoming caller.

One example UC system 10 includes an enterprise system 12, a wireless system 14, and a home system 16. An enterprise system, including the enterprise system 12 and home system 16 in this example, may include equipment and a network that is not “public,” such as the wireless system 14, the Internet 18, and the public telephone (TELCO) switch 20. The TELCO switch 20 may be a public switch telephone network (PSTN) as depicted in FIG. 1, as an example. The enterprise system 12 may communicate with the wireless system 14 through the internet or intranet 18. As non limiting examples, internet 18 may include wireless and hardwired networks. In some instances, internet 18 may further include routers, communication buffers, servers, and other communication equipment. In addition, as a further example, the enterprise system 12 may also communicate with the TELCO switch 20 via the internet 18. The home system 16 may also communicate with the enterprise system 12 and the wireless system 14 via the internet 18, the TELCO switch 20, or a combination of the internet 18 and TELCO switch 20. Another example home system 16 may be configured to permit a family to have shared ringtones among all their devices such as home system, wireless phones and perhaps on screen TV display alerts.

The enterprise system 12 may include an enterprise network 22 to support and interconnect a unified communication (UC) server 24 and public exchange (PBX) 26. The enterprise system 12 may further include enterprise computers 28 coupled via the enterprise network 22 to the UC server 24 and PBX 26.

As an example, the UC server 24 may include one or more microprocessors, controllers, memories, and network communication ports that are interconnected via communication buses and protocols. As an example, the UC server 24 may further include access to databases stored in local memories, remote memory devices, and networked memory. The UC server 24 may include computer program code stored on a tangible media. Examples of tangible media may include a memory, memory stick, flash memory, dynamic memory, magnetic tape, CD-ROM, DVD-ROM, RAM, ROM, SDRAM, SRAM, or other media capable of storing computer program code.

The enterprise computers 28 may include communication software and hardware to permit voice, multimedia, and data communications with various devices connected to the enterprise system 12 or other client devices disposed within the enterprise system 12. As an example, the enterprise computers 28 may operate as either a thick client or a thin client device or a hosted cloud-based client. In addition, the enterprise system 12 may also include a desk phone 30. The desk phone 30 may be a thin client device or a thick client device.

The home system 16 may include a traditionally connected telephone 34 coupled to the TELCO switch 20. In addition, the home system 16 may also include internet connected devices that support various levels of telecommunication capabilities. As an example, the home system may include a computer 32 configured to operate as a thick client or a thin client. As an example, the computer 32 may connect to video phone services. One example video phone service may include SKYPE®. In addition, the home system may also support voice over internet protocol (VOIP) communications.

The wireless system 14 may include various types of communication terminals 38. As an example, communication terminals 38 may include a wireless phone, a wireless terminal, or a wirelessly connected computer.

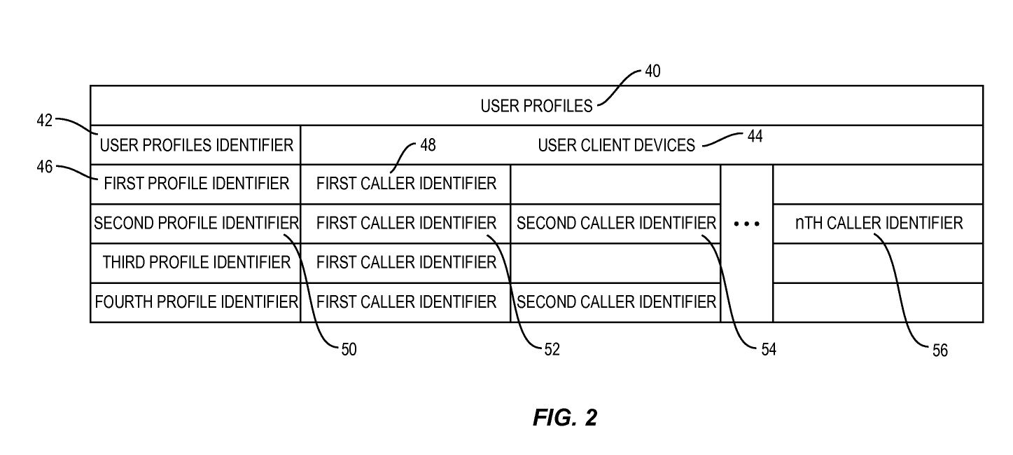

In this regard, FIG. 2 depicts an example of a user profile relational database 40 accessible by the UC server 24 of FIG. 1. The relational database 40 may include a plurality of user profile identifiers 42. An example user profile may include user account information for configuration, accessing, billing, and features associated with a user of the UC server 24. As discussed below, user profile may include an address book describing a plurality of contacts, groups of contacts, groups of client devices associated with the user of the user profile, phone address book, availability status at different times of day, message for the contact, ringtone mapping information, ringback tone mapping information, billing information, conflict resolution preferences and conflict resolution rules.

A user profile in the unified communication system includes the ability of the server to replace a lost device with a new client device without the intervention or manual process of the user. Examples include restore the phone address book, calendar, conversations in general such as emails, call history, text, voice and video messages, presence mode profiles, and other application specific data maintained by the enterprise internet and telephony.

As an example, the conflict resolution preferences on the UC server 24 may specify which of the client user devices 44 to call to resolve a conflict. As another example, the conflict resolution preferences and rules may permit the UC server 24 to evaluate and resolve conflicts between information stored in the address book a user profile and information stored on or in association with one of the user client devices 44 without user intervention.

As an example, the user profile relational database 40 may include a plurality of user profile identifiers 42 associated with user client devices 44. Example user client devices 44 may include a desk phone, an enterprise mobile phone, a thin client device, or a thick client device. Further examples of user client devices 44 may include home computers and other client devices in a home system 16. Each of the user profiles may be associated with one or more caller identifiers to the various user client devices 44, mobile terminals, enterprise mobile terminals, and client devices in the home system 16. As an example, the first profile identifier 46 may be associated with only a first caller identifier 48. Alternatively, the second profile identifier 50 may be associated with a first caller identifier 52, a second caller identifier 54, and an n^{th} caller identifier 56, where the second profile is associated with “n” user client devices 44.

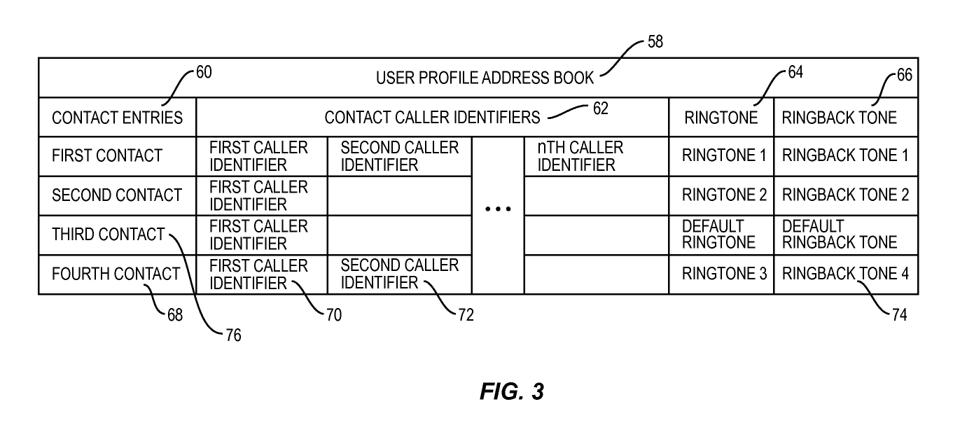

Another aspect of the user profile relational database 40 of FIG. 2 includes a user profile address book 58 or contacts associated with the user profile. As depicted in FIG. 3, an example of a user profile address book 58 may be associated with one of the user profile identifiers 42 of FIG. 2. The user profile address book 58 may include a list of contacts (entries) 60 that are associated with contact caller identifiers 62. The contact caller identifiers 62 may be used to determine from which contact an incoming call is received. In addition, each of the contacts (entries) 60 may be further associated with a ringtone 64 or a ringback tone 66.

As an example, the fourth contact 68 may be associated with a first caller identifier 70 and a second caller identifier 72. In addition, fourth contact 68 may be associated with a “Ringback tone 4” 74 of a plurality of ringback tones. As a result, when a call is received from either the first caller identifier 70 or the second caller identifier 72 of the fourth contact 68, the UC server 24 will ring the user client devices 44. In a similar fashion, the UC server 24 will stream the associated “Ringback tone 4” 74 to the one of the first caller identifier 70 or second caller identifier 72 from which the incoming call originated.

As another example, the third contact 76 may be associated with only one contact caller identifier (first caller identifier). The third contact 76 may be associated with a “Default Ringtone” and a “Default Ringback Tone.”

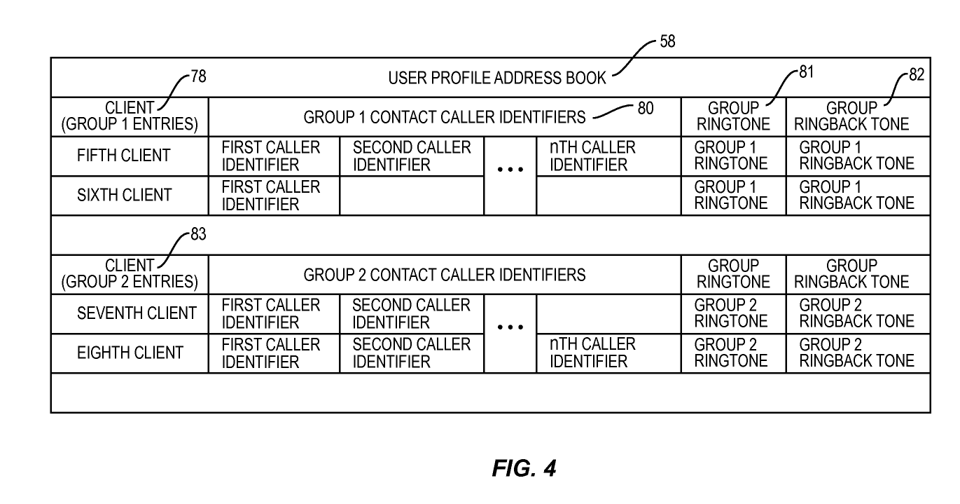

As another example of the user profile relational database 40, FIG. 4 depicts another aspect of the user profile address book 58 that includes support for group designations. The user profile address book 58 may include grouping of contacts that share characteristics. For example, a first group may be for a client (Group 1 entries) 78, which associates several entries as a group. The client (Group 1 entries) 78 may be associated with Group 1 contact caller identifiers 80, which include all the caller identifiers associated with the entries in the first group 78. In addition, the first group 78 may include a group ringtone 81 and a group ringback tone 82. The group ringtone 81 permits a user to associate a ringtone to a group of contacts in the user profile address book. Example groups may include customers, family members, friends, or co-workers. In addition, the group ringback tone 82 may permit a user to associate a desired ringback tone with a group of contacts. For example, a ringback tone may be tailored to welcome family members, friends, or business clients.

With continuing reference to the user profile relational database of FIGS. 2-4 in the context of the enterprise UC system of FIG. 1, FIG. 5 depicts an example operation of the UC server 24 in response to receipt of an incoming call (flow 102). In this example, the UC server 24 supports providing a user with a consistent ringtone at each of the user's devices that identifies a particular incoming caller. In this regard, in response to the incoming call, the UC server 24 searches a user profile relational database 40 to identify the user profile identifier associated with the incoming call (flow 104). As an example, the UC server 24 compares the destination caller identifier associated with the incoming call to the user client devices 44 to identify which of the users is the intended receiver of the incoming call.

After identifying the user profile identifier 42 associated with the incoming call, the UC server 24 determines whether the incoming caller identifier matches a contact caller identifier 62 stored in the user profile address book 58 (flow 106). If no match is found, the UC server 24 selects a default ringtone as the outbound ringtone (flow 108). Otherwise, if a match is found, the UC server 24 selects a ringtone associated with the incoming caller identifier based upon the match to the contact caller identifier 62 as the outbound ringtone (flow 110). The selected ringtone may be a ringtone assigned to one contact or to a group of contacts.

Thereafter, the UC server 24 identifies the user client devices 44 to be rung (flow 112). The UC server 24 then may determine the ringtone capabilities of each of the user client devices 44 to be rung (flow 114). Illustratively, if one of the user client devices 44 is a thin client or a desk phone, the UC server 24 may determine that the desired ringtone is unavailable on the user client devices 44 identified to be rung. Based upon the capabilities of each of the user client devices 44, the UC server 24 rings the user client devices with the outbound ringtone (flow 116). As an example, if the UC server 24 determines that the outbound ringtone is unavailable to one of the user client devices 44, the UC server 24 may stream the outbound ringtone to the one of the user client devices 44. Alternatively, if the user client device has a ringtone stored thereupon that matches the outbound ringtone, the UC server 24 will pass on the call to the device, which would ring the client device with the programmed ringtone information.

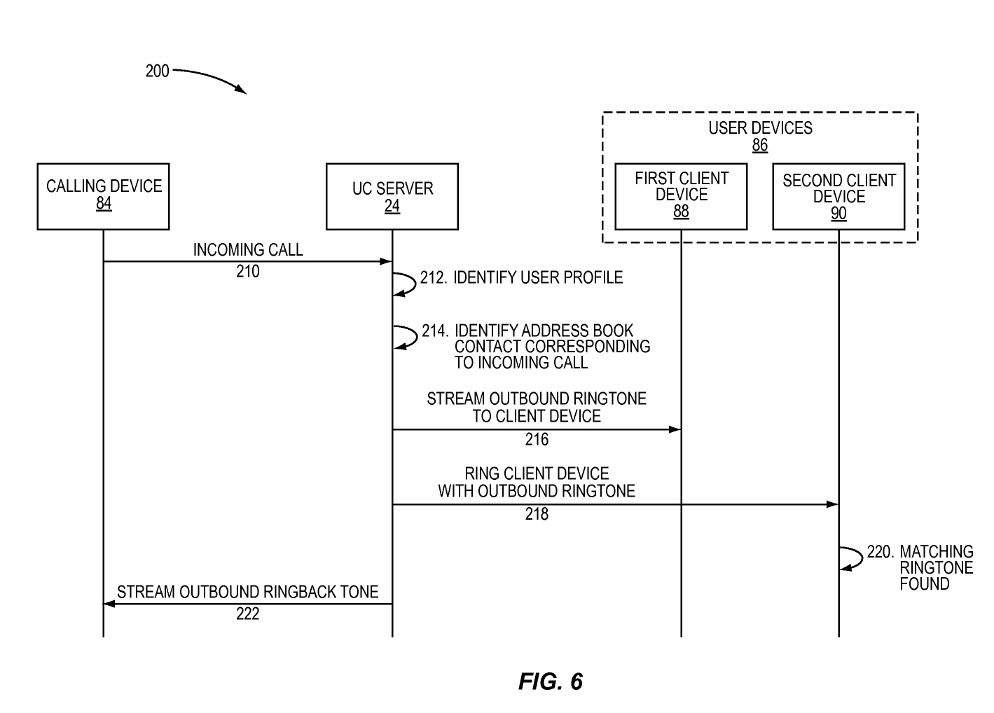

FIG. 6 further depicts a call flow diagram 200 that further illustrates the operation of a UC server 24 with continuing reference to FIGS. 1-3. Calling device 84 initiates an incoming call through the internet 18 (flow 210), which is received by the UC server 24. Upon receipt of the incoming call, the UC server 24 identifies a user profile identifier that corresponds to the incoming caller identifier (flow 212). After the user profile associated with the incoming call is identified, the UC server identifies an address book contact that corresponds to the incoming caller identifier (flow 214).

Depending upon the capability of the user devices 86, the UC server 24 will alert the user devices 86. Illustratively, if the UC server 24 determines that the first client device 88 does not have a matching ringtone or is unable to verify the ringtone capability, the UC server 24 streams the outbound ringtone to the first client device 88 (flow 216).

Alternatively, as an example, if the second client device 90 supports the outbound ringtone, the second client device 90 will ring the ringtone when it receives the call from the UC server 24 (flow 218).

As will be discussed later in greater detail, the UC server may also stream back a ringback tone that is associated with a contact stored in the user profile address book to the calling device 84 (flow 222). Alternatively, the UC server 24 may stream back a ringback tone that is associated with a group of contacts. Example groups may include family, friends, co-workers, customers, clients, or custom groups within the enterprise examples include “Mobile Hardware” and “Support” as depicted in FIG. 4.

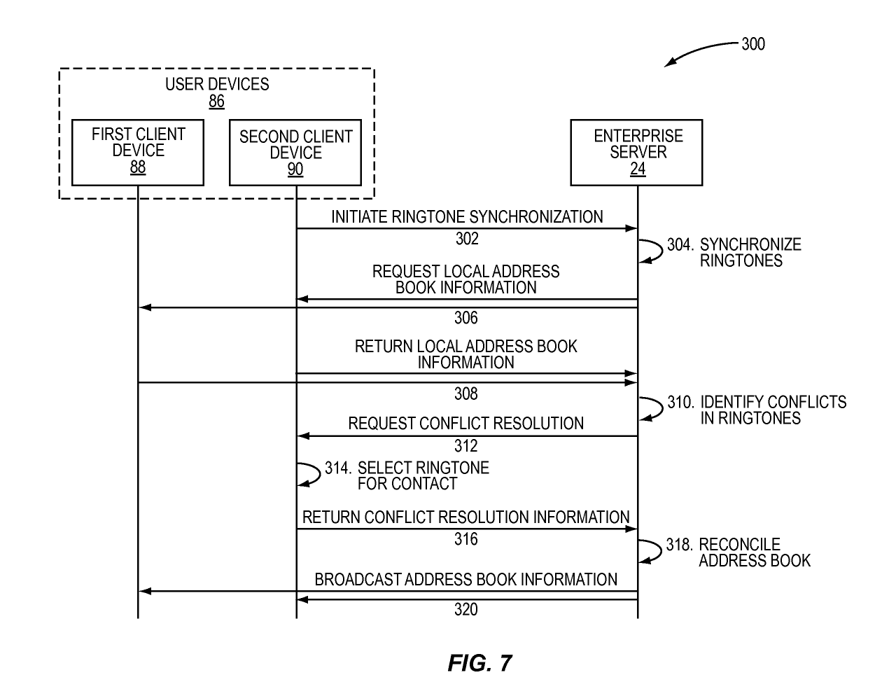

FIG. 7 further depicts a call flow diagram 300 that further illustrates the operation of an UC server 24 with continuing reference to FIGS. 1-3 and 5. The second client device 90 initiates a request to initiate ringtone synchronization, which is received by the UC server 24 (flow 302). The request to initiate ringtone synchronization may be for a single contact, multiple contacts, or all contacts in an address book. In response to the request to synchronize ringtones, the UC server 24 determines the user profile associated with the second client device 90 (flow 304).

After the user profile is identified, the UC server 24 identifies the user client devices associated with the user profile and requests each of the identified user client devices to provide local address book information (flow 306). The local address book information may include all or some of the address book information associated with one or more contacts listed in the user profile address book 58. The requested local address book information may specify data for a single contact in the user profile address book 58. Alternatively, the synchronization process may be done on a subset of identified contacts in the user profile address book 58.

In response to the request for address book information, each client device that has a local address book returns address book information. As an example depicted in call flow diagram 300, the first client device 88 and second client device 90 both return address book information stored in their respective local address books (flow 308).

Thereafter, the UC server 24 examines the returned local address book information to identify conflicts between the ringtones associated with the contacts in the user profile address book 58 and the ringtones associated with the contacts in the returned local address book information flow 310. As an example, the conflicts may be between contact names, contact caller identifiers 62, or ringtones.

For example, the identified conflict may identify a contact caller identifier that is not yet associated with a contact stored in the user profile address book. The identified conflict may identify a difference between contact (entries) in the user profile address book and the local address book that are associated with the same contact caller identifiers.

As another example, the identified conflict may identify differences between the ringtone associated with a particular set of contact caller identifiers 62 stored in the local address book of a user client and the user profile address book. As still another example, the identified conflict may identify differences between local address books stored in the first client device 88 and the second client device 90.

After a conflict is recognized, the UC server 24 sends a request conflict resolution message to the second client device 90, which initiated the request to initiate ringtone synchronization (flow 312). The request conflict resolution message may include conflict information that describes the identified conflict. The conflict information may include a contact entry, contact caller identifiers, and ringtone information to permit the user of the second client device 90 to select a desired ringtone to be associated with a particular contact or contact caller identifiers. As part of the conflict resolution, the UC server may stream or request the client to play both the ringtones to help the user in his conflict decision. Similarly, depending upon the type of conflict identified, the conflict information may include information stored in local address books of user client devices.

Upon receipt of the conflict information, the second client device 90 is configured to display the relevant conflict information to the user of the second client device 90. Based upon the displayed conflict information, the user of the second client device 90 provides a response to resolve the identified conflict (flow 314). The second client device 90 returns conflict resolution information to the UC server 24 (flow 316). Based upon the conflict resolution information, the UC server 24 reconciles ringtones stored in the local address book ringtones and the ringtone stored in the user profile address book (flow 318). As an alternative example, the conflict information may include a preferred contact entry or other address book information to be reconciled.

Thereafter, the UC server 24 broadcast update address book information to each of the user devices 86 that have a local address book, or update the information on the next synchronization. As an example, the UC server 24 may broadcast updated ringtone information to the first client device 88 and the second client device 90 (flow 320).

As an alternative example, as discussed below, the call flow diagram 300 may be adapted to synchronize other information stored in the user profile address book 58. For example, the same flow may be used to synchronize a ringback parameter associated with a user profile stored in the UC server 24 and a ringback parameter stored in a local address book of a mobile terminal in a wireless network.

As another alternative example, the UC server 24 may initiate the synchronize ringtones (flow 304) without being prompted by the initiate ringtone synchronization request from one of the user devices (flow 302). In this case, the UC server 24 periodically undertakes to synchronize the information stored between devices and identifies one of the user devices 86 to request conflict resolution information. Otherwise, the UC server 24 may execute a conflict resolution operation that does not require user intervention.

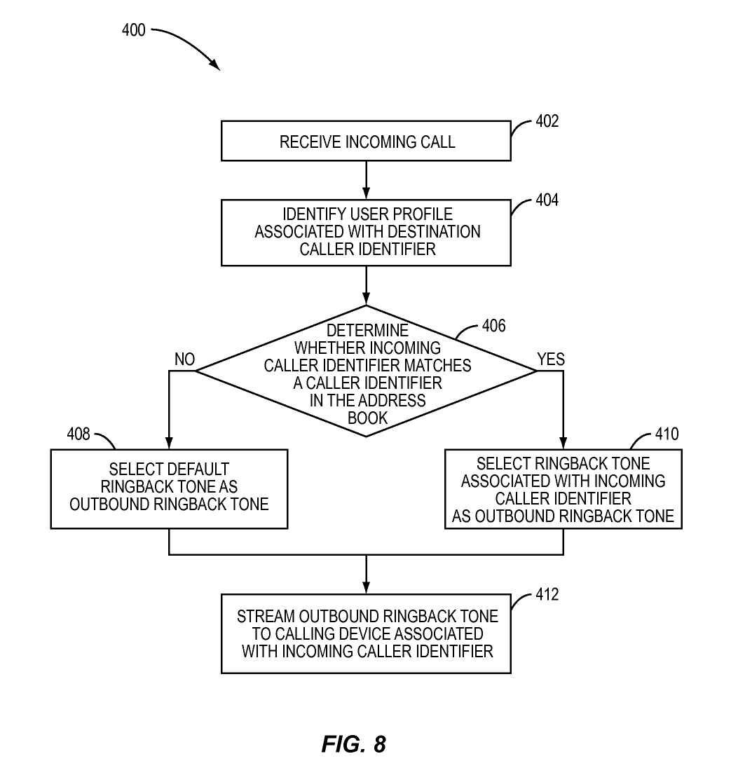

FIG. 8 depicts an operation of the UC server 24 in response to receipt of an incoming call (flow 402). In response to the incoming call, the UC server 24 searches the user profile relational database 40 to identify the user profile identifier 42 associated with the destination caller identifier of the incoming call (flow 404). As an example, the UC server 24 compares the destination caller identifier associated with the incoming call to the user client devices 44 associated with a user profile identifier 42 to identify which user is the intended receiver of the incoming call. After identifying the user profile identifier 42 associated with the incoming call, the UC server 24 determines whether the incoming caller identifier matches a caller identifier stored in the user profile address book 58 (flow 406). If none of the contact caller identifiers match the incoming caller identifier, the UC server 24 selects a default ringback tone as an outbound ringback tone (flow 408). Otherwise, the UC server 24 selects a ringback tone associated with the incoming caller identifier as the outbound ringback tone (flow 410). After the outbound ringback tone is selected, the UC server 24 streams the outbound ringback tone to the calling device associated with the incoming caller identifier (flow 412).

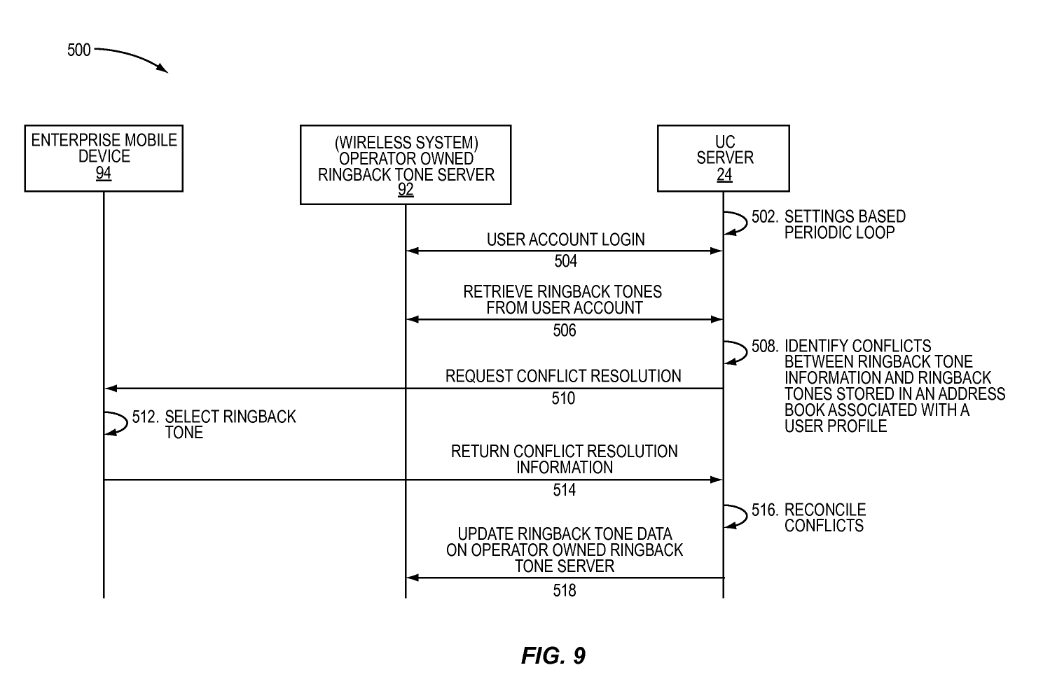

FIG. 9 depicts a call flow diagram 500 for periodically synchronizing ringback tones stored on the UC server 24 with ringback tones stored on a wireless system's operator owned ringback tone server 92.

Based upon user or system settings, the UC server 24 enters a periodic loop to invoke a ringback tone reconciliation operation (flow 502). As an alternative example, the UC server 24 may receive a request to invoke a ringback tone reconciliation operation from an user device or an enterprise mobile device 94. The UC server 24 accesses the owner operated ringback tone server 92 via a user account login process (flow 504) and retrieves the ringback tone information from the user account (flow 506).

The UC server 24 identifies conflicts in ringback tones between the user profile address book information and the retrieved ringback tone information gathered from the operator owned ringback tone server 92 (flow 508). Thereafter, the UC server 24 sends conflict information in a request conflict resolution message to the enterprise mobile device 94, where the enterprise mobile device 94 is one of the user client devices associated with the user profile identifier of the user (flow 510). The conflict information may provide a ringtone stored on the UC server 24 to the enterprise mobile device 94. Alternatively, the UC server 24 may determine an appropriate ringback tone selection based upon a predetermined set of rules.

Based upon the conflict resolution information, the enterprise mobile device 94 selects a preferred ringback tone to be associated with a contact listed in the user profile address book 58 (flow 512). Thereafter, the enterprise mobile device 94 returns conflict resolution information (flow 514) to the UC server 24. The conflict resolution information may include a ringtone stored on the enterprise mobile device that is selected by the user of the enterprise mobile device 94.

Upon receipt of the conflict resolution information, the UC server 24 reconciles the user profile address book to be consistent with the conflict resolution information. In addition, the UC server 24 reconciles differences between the retrieved ringback tones from the user account on the operator owned ringback tone server 92 (flow 516).

Thereafter, the UC server 24 sends updated ringback tone information to the operator owned ringback tone server (flow 518). The operator owned ringback tone server may use the updated ringtone information to update the ringback tones from the user account associated with the enterprise mobile device 94. As an example, the enterprise mobile device 94 may provide a ringback tone to the owner operated ringback tone server 92.

As an alternative example, as discussed below, the call flow diagram 500 may be adapted to synchronize other information stored in the user profile address book 58. For example, the same flow may be used to synchronize a ringtone parameter associated with a user profile stored in the UC server 24 and a ringtone parameter stored in a local address book of the enterprise mobile device 94 in a wireless network.

As another alternative example, similar to flow 302 of FIG. 7, the enterprise mobile device 94 may initiate the ringback synchronization operation. In this case, the UC server 24 will undertake to synchronize the information stored between the owner operator ringback tone server 92 and the UC server 24. As another example variation, the UC server 24 may execute a conflict resolution operation that does not require user intervention from the enterprise mobile device 94.

Note that the various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices. As an example, a combination of computing devices may include a combination of a DSP and a microprocessor, a plurality of microprocessors, one or more microprocessors in conjunction with a DSP core, or any other such configuration.

The embodiments disclosed herein may be embodied in hardware and in instructions that are stored in memory, and may reside, for example, in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of computer readable medium known in the art. An exemplary storage medium is coupled to the processor such that a processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. For example, the operational steps illustrated in the flow chart diagrams may be subject to numerous different modifications. Information, data, and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Those skilled in the art will recognize improvements and modifications to the preferred embodiments of the present invention. All such improvements and modifications are considered within the scope of the concepts disclosed herein and the claims that follow.

What is claimed is:

1. A ringtone management system, comprising:
a server configured to:
receive an incoming call from an incoming caller identifier, wherein the incoming call is directed to a destination caller identifier;
identify a user profile among a plurality of user profiles that correspond to the destination caller identifier, wherein the user profile is associated with a plurality of client devices and a plurality of contacts;
determine whether the plurality of contacts includes a contact associated with a caller identifier that matches the incoming caller identifier;
in response to determination that the plurality of contacts includes the contact associated with the caller identifier that matches the incoming caller identifier, select a ringtone associated with the caller identifier as an outbound ringtone; and
ring the plurality of client devices with the same outbound ringtone.

2. The ringtone management system of claim 1, wherein the server is further configured to select a default ringtone as the outbound ringtone in response to the determination that the user profile fails to include the contact associated with the caller identifier that matches the incoming caller identifier.

3. The ringtone management system of claim 1, wherein the server is further configured to:
determine whether the user profile includes a ringtone associated with the caller identifier that matches the incoming caller identifier; and
in response to the determination that the user profile fails to specify the ringtone associated with the caller identifier that matches the incoming caller identifier, select a default ringtone as the outbound ringtone.

4. The ringtone management system of claim 1, wherein in further response to the determination that the user profile includes the contact associated with the caller identifier that matches the incoming caller identifier, the server is further configured to:
select a ringback tone associated with the caller identifier as an outbound ringback tone; and
stream the ringback tone to a calling device associated with the incoming caller identifier.

5. The ringtone management system of claim 1, wherein the user profile comprises a plurality of client caller identifiers and an address book;
wherein each of the client caller identifiers is associated with one of the plurality of client devices;
wherein the address book includes a plurality of address book entries, and each of the address book entries corresponds to one of the plurality of contacts.

6. The ringtone management system of claim 5, wherein each of the address book entries includes a caller identifier associated with the ringtone.

7. The ringtone management system of claim 5, wherein at least one address book entry of the plurality of address book entries includes more than one caller identifier associated with the ringtone.

8. The ringtone management system of claim 5, wherein the server is further configured to:
identify which of the plurality of client devices fails to support the outgoing ringtone; and
stream the outgoing ringtone to an identified client device of the plurality of client devices that fails to support the outgoing ringtone.

9. The ringtone management system of claim 5, wherein the caller identifier of each address book entry is further associated with a ringback tone.

10. The ringtone management system of claim 9, wherein the server is further configured to:
select the ringback tone associated with the caller identifier that matches the incoming caller identifier as an outgoing ringback tone associated with the incoming call; and
stream the outgoing ringback tone to a caller device associated with the incoming caller identifier.

11. A ringtone management method, comprising:
receiving an incoming call from an incoming caller identifier, wherein the incoming call is directed to a destination caller identifier;
identifying a user profile among a plurality of user profiles that correspond to the destination caller identifier, wherein the user profile is associated with a plurality of client devices and includes a plurality of contacts;
determining whether the plurality of contacts includes a contact associated with a caller identifier that matches the incoming caller identifier;
in response to determination that the plurality of contacts includes the contact associated with the caller identifier that matches the incoming caller identifier, selecting a ringtone associated with the caller identifier as an outbound ringtone; and
ringing the plurality of client devices with the outbound ringtone.

12. The method of claim 11, further comprising in response to determination that the plurality of contacts does not include the contact associated with the caller identifier that matches the incoming caller identifier, selecting a default ringtone as the outbound ringtone.

13. The method of claim 11, wherein selecting the ringtone associated with the caller identifier as the outbound ringtone comprises:
determining whether the plurality of contacts includes a ringtone associated with the caller identifier that matches the incoming caller identifier; and
in response to determination that the plurality of contacts fails to specify the ringtone associated with the caller identifier that matches the incoming caller identifier, selecting a default ringtone as the outbound ringtone.

14. The method of claim 11, wherein in further response to determination that the plurality of contacts includes the contact associated with the caller identifier that matches the incoming caller identifier, selecting a ringback tone associated with the caller identifier as an outbound ringback tone; and
streaming the ringback tone to a calling device associated with the incoming caller identifier.

15. The method of claim 11, wherein determining whether the plurality of contacts includes the contact associated with the caller identifier that matches the incoming caller identifier further comprises:
in response to determination that the plurality of contacts fails to include a contact with a caller identifier that matches the incoming caller identifier, selecting a default ringtone as the outbound ringtone.

16. The ringtone management system of claim 11, wherein the user profile comprises a plurality of client caller identifiers and an address book;
wherein each of the client caller identifiers is associated with one of the plurality of client devices;
wherein the address book includes a plurality of address book entries, and each of the address book entries corresponds to one of the plurality of contacts.

17. A method for reconciling ringtones across multiple devices, comprising:
identifying, from the user profile, one or more client devices having a local address book;
requesting, from each of the one or more client devices having the local address book, local address book information;
resolving conflicts between the local address book information received from each of the one or more client devices having the local address book and an address book associated with the user profile to generate conflict resolution information;
reconciling ringtones stored in the address book associated with the user profile based upon the conflict resolution information; and
broadcasting updated local address book information to each client device of the one or more client devices.

18. The method of claim 17, wherein reconciling the ringtones stored in the address book associated with the user profile based upon the conflict resolution information further comprises reconciling the ringtones stored in the local address book of each client device of the one or more client devices based upon the conflict resolution information to generate the updated address book information.

19. The method of claim 17, wherein resolving the conflicts between the local address book information and the address book associated with the user profile to generate the conflict resolution information comprises:
identifying conflicts between ringtone information stored in the local address book of each client device and the address book associated with the user profile; and
generating the conflict resolution information.

20. The method of claim 17, wherein generating the conflict resolution information comprises:
requesting the conflict resolution information from the incoming caller identifier; and
receiving the conflict resolution information from the incoming caller identifier.

21. The method of claim 20, wherein requesting the conflict resolution information from the incoming caller identifier further comprises sending the conflict information to the incoming caller identifier.

22. The method of claim 17, further comprising:
receiving a request to initiate ringtone synchronization from an incoming caller identifier; and
identifying a user profile associated with the incoming caller identifier.

23. The method of claim 22, further comprising updating the local address book information for each client device.

24. An apparatus for reconciling ringtones across multiple devices, comprising:
a server configured to:
identify, from the user profile, one or more client devices having a local address book;
request, from each of the one or more client devices having the local address book, local address book information;
resolve conflicts between the local address book information received from each of the one or more client devices having the local address book and an address book associated with the user profile to generate conflict resolution information;
reconcile ringtones stored in the address book associated with the user profile based upon the conflict resolution information; and
broadcast updated local address book information to each client device of the one or more client devices.
